(19) United States
(12) Patent Application Publication
(10) Pub. No.: US 2013/0139626 A1
(43) Pub. Date: Jun. 6, 2013

(54) Power-economizing, integral electric vehicle drive mechanism with independent rear suspension for an electric vehicle with a multi-speed transmission capable of multiplying the torque of the electric motor at low speeds

(71) Applicant: Brooks Alexander Agnew, Concord, NC (US)

(72) Inventor: Brooks Alexander Agnew, Concord, NC (US)

(21) Appl. No.: 13/669,488

(22) Filed: Nov. 6, 2012

Related U.S. Application Data
(60) Provisional application No. 61/565,592, filed on Dec. 1, 2011.

(51) Int. Cl. B60L 11/00; B62D 65/12; B62D 65/10

(52) U.S. Cl. CPC B60L 11/00; B62D 65/10; B62D 65/12
USPC 74/325; 29/428; 29/469

(57) ABSTRACT

The invention is an electric vehicle subassembly that has a drive with a front wheel drive multi-speed transmission with independent suspension mounted in the rear of the vehicle. The front wheel drive transmission is not steerable. The invention is also an electric vehicle drive subassembly with a drive having an electric motor, an input shaft of a multi-speed transmission, a driven gear cluster, a differential, and the axles of the vehicle all arranged in parallel. The invention also comprises methods for efficiently manufacturing such electric vehicles.

### CROSS REFERENCE TO RELATED APPLICATIONS

The present application claims the priority of U.S. provisional application No. 61/565,592, filed on Dec. 1, 2011, which is herein incorporated by reference.

### BACKGROUND OF THE INVENTION

This invention relates to the technical field of automobile manufacture. More particularly, the present invention relates to manufacturing an electric vehicle.

1. Field of the Invention

2. Description of Related Art

The most common form of automobile propulsion or traction with an electric motor is with a single motor mounted through a single-speed gear reduction to the rear or front wheel drive wheel(s). The current state of the art in electric vehicle traction is with a single speed transaxle or application of motor torque to the vehicle's drive wheels. The torque of an electric motor is distributed in a linear fashion across the entire workable rotations per minute (RPM) range of the motor. This is a performance advantage of an electric motor over a traditional internal combustion motor. Those familiar with the art will recognize that the major car makers have chosen to install a single speed axle, or an in-wheel drive mechanism, with a fixed ratio of gears or belts between the electric motor and the wheels touching the ground. The weakness in this design is the very low speed performance when the electric vehicle is accelerating or beginning to move or traveling up an incline where the weight of the vehicle is multiplied by the grade for an increased resistance on the electric traction motor. To accelerate a vehicle at equal rates using a single-speed drive, the amount of energy required is significantly larger than using the proposed invention of a modular drive with a multi-speed transmission. For example, in a small truck with a significant payload on a positive grade of 5%, so much torque is required to begin to move the vehicle, that this requirement may exceed the electric vehicle's ability to supply it. The vehicle may not move at all, or may slightly move with the addition of inordinate amounts of power drawing from the storage device. Review of the relevant literature reveals that there exists a need for improved transmission systems to deliver electric motor torque to a vehicle's drive wheels in a more effective manner, and for improved, more modular methods of manufacturing such vehicles.

### BRIEF SUMMARY OF THE INVENTION

The present invention provides a torque-economizing, integral electric vehicle drive mechanism with independent rear suspension for an electric vehicle with a multi-speed transmission capable of multiplying the torque of the electric motor at low speeds and constructed in a filly modular subassembly for rapid manufacturing and to more easily facilitate vehicle repair. The current state of the art is a front or rear wheel drive system of separate components to create a single speed transaxle making use of the linear torque curve and broad power band of an electric motor in order to power the vehicle. The proposed invention is a significant improvement over the current state of the art, because utilizing multiple gear ratios in a multi-speed transmission at higher gear ratios the amount of energy required to accelerate the vehicle is significantly lower with lower gear ratios. The higher the ratio of gears between the motor and the wheels of the vehicle, the less energy is required to accelerate the vehicle. The addition of a multi-speed transmission between the electric motor and the wheels of the vehicle is significantly more economical with the available energy in the batteries. The transmission may be manually shifted or continuously varied between the input and output shafts of the transmission in order to accomplish this invention. Further, the invention proposes that the electric drive axis is parallel to the driven gears in the transmission, and to the drive axles, and to the axis of rotation of the wheels which is a significant improvement over the current right-angle motor alignment in the typical electric vehicle. Further, the integral nature of the subassembly facilitates rapid assembly and disassembly for greatly improved maintenance of the vehicle.

The disclosed invention is a superior, novel, and unique solution to this common shortcoming in electric vehicle design. The disclosed invention places a multi-speed, front-wheel-drive manual or automatic transmission into position to drive the rear wheels of the electric vehicle. The present invention is based on the discovery of the mechanical improvement of a front wheel drive transmission, with the motor drive shaft, drive gear and cluster gear in parallel with the drive axles of the vehicle, is more efficient than the traditional method of delivering the motor's torque through an inline transmission, a drive shaft, and then a perpendicular differential to the wheels.

In a Front Wheel Drive (FWD) vehicle of the prior art, the differential is located inside or directly connected to the transmission and from there the Constant Velocity (CV) axles supply power directly to the front wheels. With power being supplied almost directly to the front wheels there is a much smaller loss of power when compared to Rear Wheel Drive (RWD) vehicles. The decreased loss of power through the drive-train results in better power economy and better acceleration because almost all of the engine's energy in a FWD vehicle is making it to the wheels. FWD vehicles do fairly well on snow ridden and slippery roads because all of the weight from the engine and transmission is sitting over the wheels with power supplied to them, resulting in increased traction.

A feature of the disclosed invention is to mount the FWD transmission and motor in the vehicle in the RWD location. The inventors have determined this to be the best location to optimize mechanical and performance conditions. The efficiency and compactness of the motor and transmission together as one subassembly and the straight line driving stability of the driveline located over and driving the rear wheels extends the range of the vehicle between charges of the electric power unit as compared to the traditional one-speed or inline multi-speed driveline setups. The resistance to rolling is measurably less than for vehicles with a traditional inline drive system with a right-angle differential, which is a significant improvement over the current art as the less rolling resistance between the storage device and the road under the wheels of the vehicle, the less energy is required to move the vehicle in normal operation, thus extending the range the vehicle can drive on a single charge.

Another feature of the invention is to mount an electric motor to a FWD multi-speed transmission, and then to mount that transmission in the rear of the electric vehicle, similar to the standard RWD mounting position, except with the motor turning in the same direction as the transmission drive axles, and the wheels of the vehicle. The addition of a filly independent suspension in the RWD position also improves the handling of the vehicle in nearly all ordinary on-road conditions and some off-road conditions and may improve ground clearance over the current art.

Another feature of the invention is to install the FWD transmission in a carriage as a subassembly with the electric motor, wheels, hubs, brakes, axles, control arms, and shocks so as to facilitate rapid assembly to an electric vehicle during a manufacturing operation.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a depiction of the prior art, showing a Rear Wheel Drive (RWD) vehicle with the engine in the front of the vehicle.

FIG. 2 is a depiction of the prior art, showing a Rear Wheel Drive (RWD) vehicle with the engine and transmission in the rear of the vehicle.

FIG. 3 is a schematic of the present invention, showing the electric motor adapted to the FWD transaxle and mounted to the rear of the vehicle.

### DETAILED DESCRIPTION OF THE INVENTION

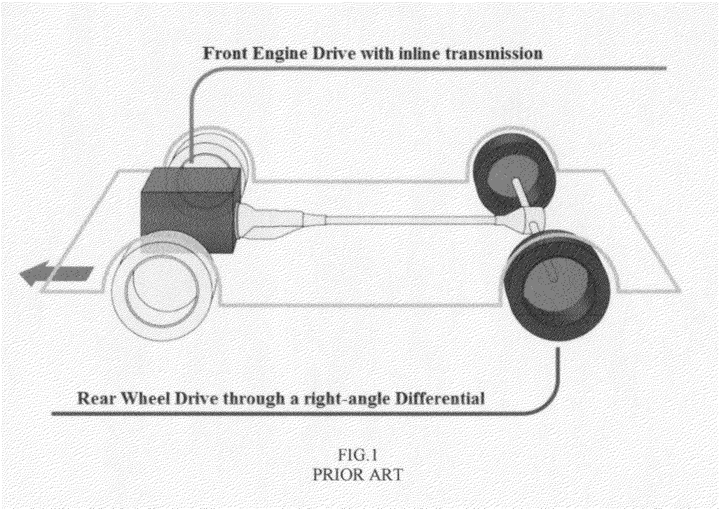

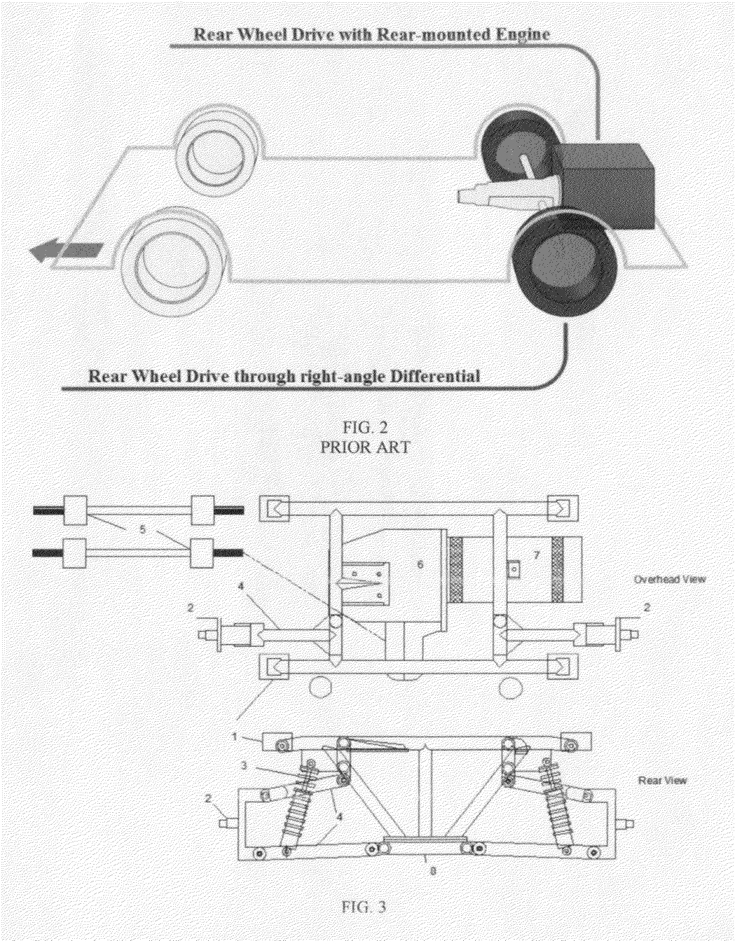

Referring now to the invention in more detail, a front engine, rear wheel drive vehicle is very common. This is mechanically inefficient as the mechanical drag of the spiral/bevel gears of the differential and the changing of the direction of the energy through a ring and pinion gear is significant and not productive toward moving the vehicle forward or backward. This results in a loss of energy. FIG. 1 shows a prior art vehicle design with the engine located in the front of the vehicle with a drive shaft delivering power to the rear wheels through a right-angle differential. FIG. 2 shows a prior art vehicle with the engine located in the front of the vehicle with a differential turning in the same plane of rotation as the vehicle's wheels. Those familiar with the art will recognize that the design of FIG. 2 is more efficient with the torque provided by the motor delivered along the same plane of rotation and in close proximity to the drive wheels of the vehicle.

FIG. 3 shows the proposed invention in concept. The main component is (1) the cross frame mount. This is important to the rapid manufacturing of the vehicle, as it presents a structural frame member to the existing rear frame of the vehicle, such as a small pickup truck frame for easy bolt-on assembly of the entire sub-assembly. In manufacture, the vehicle is simply lowered onto the structural cross-frame member, or the subassembly is raised into position for the same effect, (1) and two bolts of suitable size and strength are passed through the brackets, forming a very strong shear force connection. The two spindles (2) pass through ordinary wheel bearings to support the hub and brake assembly. The shock absorbers (3) are variable ride weight units that allow the vehicles some adjustment to compensate for different load factors. The upper and lower control arm (4) control the vertical spindle assembly (2) and are attached to the shock absorber (3) and the upper cross-frame member (1) to complete a mechanism that allows the rear wheels to track without losing traction against the road. The drive motor (7) is mounted to the multi-gear transmission (6) and connected to the two rear wheels through two independent constant-velocity joints (axles) (5).

A multi-speed transmission multiplies the torque of a drive motor to the wheels, greatly reducing the amount of energy it takes to accelerate from a stationary position, or from a lower speed to a higher speed. Further, most of the energy required to operate an electric vehicle is consumed during the acceleration period, so providing a choice to the driver for a more suitable gear for each driving condition, optimizes the amount of energy required at each moment of driving.

The integral frame structure of the rear wheel drive subassembly described in the current invention is designed to be modular so that it can be installed all at once into the vehicle, thus greatly reducing the amount of time and complexity for assembling the vehicle, or for service when a major component needs replacing or repair.

In an embodiment, the present invention comprises an electric vehicle drive that consists of a non-steerable, front wheel drive transaxle with independent suspension mounted in the rear of the vehicle as a rear wheel drive vehicle.

In another embodiment, the present invention comprises an electric vehicle drive with alignment of the electric motor, input shaft of a multi-speed transmission, the driven gear cluster, the differential, and the axles are in parallel.

In yet another embodiment, the present invention comprises a modular, integral, rear wheel drive unit for an electric vehicle constructed in such a way as to install the electric motor, transmission, axles, brakes, and wheels as a single subassembly.

In yet another embodiment, the present invention comprises a bolt-on mounting process for an integral electric vehicle drive subassembly such that with less than five (5) bolts, the entire rear suspension, motor, transmission, brakes and wheels may be assembled into an electric vehicle chassis.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Moreover, the terms “consisting”, “comprising” and other derivatives from the term “comprise” are intended to be open-ended terms that specify the presence of any stated features, elements, steps, or components, and are not intended to preclude the presence or addition of one or more other features, elements, integers, steps, components, or groups thereof. Moreover, Applicants have endeavored in the present specification and drawings to draw attention to certain features of the invention, it should be understood that the Applicant claims protection in respect to any patentable feature or combination of features referred to in the specification or drawings. The drawings are provided to illustrate features of the invention, but the claimed invention is expressly not limited to the illustrated embodiments.

We claim:

1. An electric vehicle comprising a drive, said drive comprising a front wheel drive transmission with independent suspension mounted in the rear of the vehicle.

2. The electric vehicle of claim 1, wherein said front wheel drive multi-speed transmission is not steerable.

3. An electrical vehicle of claim 1 comprising a drive, said drive having an electric motor, an input shaft of a multi-speed transmission, a driven gear cluster output shaft, a differential, and the axles of the vehicle all arranged in parallel.

4. A rear wheel drive unit for an electric vehicle, comprising an electric motor, a multi-speed transmission, axles, brakes, and wheels, wherein said electric motor, transmission, axles, brakes, and wheels are installed as a single subassembly.

5. A method of manufacturing an electric vehicle, comprising installing an electric motor, a multi-speed transmission, axles, brakes, and wheels in a single subassembly.

6. A method of manufacturing an electric vehicle, comprising installing a rear suspension, a motor, a multi-speed transmission, brakes, and wheels into a vehicle chassis with less than five bolts, comprising the steps of:
(1) Aligning the vehicle chassis with a subassembly below it, said subassembly comprising an electric drive motor, multi-speed transmission, axles, brakes, and wheels;
(2) Raising said subassembly, or lowering said vehicle chassis so that bushings of the subassembly mount on the subassembly and brackets for the subassembly mount on the vehicle are aligned to allow a bolt to secure the subassembly to the vehicle chassis:
(3) Attaching motor cables to the drive motor in the proper polarity;
(4) Attaching a hydraulic brake line, and bleeding the air from them;
(5) Attaching emergency brake cables to caliper brake actuating levers;
(6) Attaching wiring harness connectors for a speedometer, a neutral safety switch and reverse switches;
(7) Attaching shifting cables to the multi-speed transmission's proper shifting levers; and
(8) Lowering vehicle to the driving surface.
